(19) United States
(12) Patent Application Publication
(10) Pub. No.: US 2025/0176471 A1
(43) Pub. Date: Jun. 5, 2025

(54) VERTICAL GARDEN ASSEMBLY, BRACKET, AND KIT

(71) Applicant: Grow King 905 Ontario Ltd., Bolton (CA)

(72) Inventors: Frank Bisogno, Bolton (CA); Rolf Ohrstrom, Palgrave (CA)

(21) Appl. No.: 19/046,089

(22) Filed: Feb. 5, 2025

Related U.S. Application Data
(63) Continuation of application No. PCT/CA2023/051043, filed on Aug. 4, 2023.
(60) Provisional application No. 63/395,558, filed on Aug. 5, 2022.

(51) Int. Cl. A01G 7/04; A01G 9/02

(52) U.S. Cl. CPC A01G 7/045; A01G 9/023

(57) ABSTRACT

A bracket for positioning between an upper plant tray and a lower plant tray is disclosed. The bracket comprises a bracket body having a body proximal end attachable to a vertical support surface, and a body distal end spaced apart from the body proximal end. The bracket body has a body upper surface extending lengthwise between the body proximal end and the body distal end for supporting the upper plant tray. The bracket further comprises at least one lamp-mounting clip affixed to the bracket body. Each of the lamp-mounting clips includes a first finger and a second finger spaced apart from the first finger lengthwise along the bracket body to retain a grow lamp between the first and second fingers and beneath the body upper surface.

### CROSS-REFERENCE TO RELATED APPLICATION

This application is a continuation of International Application No. PCT/CA2023/051043 filed Aug. 4, 2023, which claims the benefit of U.S. Provisional Patent Application No. 63/395,558 filed Aug. 5, 2022, the entirety of each of which is incorporated herein by reference.

### FIELD

This application relates generally to the field of vertical gardens, and in particular to brackets that include an upper surface for supporting a plant tray, and at least one lamp retaining clip for retaining a grow lamp beneath the upper surface.

### BACKGROUND

U.S. Pat. No. 9,775,447B2 (Wiemer et al.) discloses an illuminated shelving system having light bars attached to the shelves. The light bars are electrically connected to a power strip that conducts electricity from a wall outlet to a plurality of light bars.

US20160360712A1 (Yorio et al.) discloses systems and methods for improving efficiency and yield in plant grow operations including improvements in LED grow lighting fixtures, components and systems, and their applications to plant grow operations. Improvements for directional control and efficiency in lighting and methods and systems used in plant grow applications and operations including temperature regulation and control, soil and grow media regulation and vertical farming are also disclosed.

U.S. Pat. No. 10,517,227B2 (Ma) discloses an indoor three-dimensional planting frame including a composite frame, a control system, planting pots and LED light panels. The composite frame is assembled from a plurality of side baffles, fixing rings and fixing plates. The side baffles are vertically arranged on both sides of a frame body of the composite frame. Ends of adjacent side baffles are connected to the fixing rings. The fixing rings are arranged horizontally as rectangular rings of beams and a plurality of mounting holes are arranged thereon. The fixing plates are bracket plates. The LED light panels are fixed at the bottom of the fixing plates with screws, and multiple LED light wicks are arranged on the LED light panels. The indoor three-dimensional planting frame helps control the plant growth photoperiod and photomorphogenesis by controlling the work cycle of the grow lights and the fans.

US20210307267A1 (Baik et al.) discloses a hydroponics apparatus including a housing, two or more channels provided vertically on one side of the housing to be spaced apart from each other, brackets coupled to the channels, and cultivation modules seated on the brackets. A plurality of cultivation modules is fitted and coupled to each other to have an extended form and water channels are formed to communicate with each other. The cultivation modules in the extended form are coupled to each channel and seated through a plurality of brackets disposed in a horizontal direction. The plurality of brackets are coupled to the channels so that heights are gradually increased or decreased from one-side bracket in the horizontal direction to the other bracket in the horizontal direction to form an inclination of the water channel.

### SUMMARY

The following is intended to introduce the reader to the detailed description that follows and not to define or limit the claimed subject matter.

In one aspect, a bracket for positioning between an upper plant tray and a lower plant tray is disclosed. The bracket comprises a bracket body having a body proximal end attachable to a vertical support surface, and a body distal end spaced apart from the body proximal end. The bracket body has a body upper surface extending lengthwise between the body proximal end and the body distal end for supporting the upper plant tray. The bracket further comprises at least one lamp-mounting clip affixed to the bracket body. Each of the lamp-mounting clips includes a first finger and a second finger spaced apart from the first finger lengthwise along the bracket body to retain a grow lamp between the first and second fingers and beneath the body upper surface.

In some examples, the bracket body and the at least one lamp-mounting clip are of unitary construction.

In some examples, the at least one lamp-mounting clip is a plurality of lamp-mounting clips that are spaced apart lengthwise along the bracket body.

In some examples, the first and second fingers of each lamp-mounting clip are resiliently flexible between laterally inward and outward positions, biased to the laterally inward position, and urged towards the laterally outward position when the grow lamp is received between the first and second fingers.

In some examples, the first and second fingers of each lamp-mounting clip extend downwardly from a finger proximal end to a finger distal end.

In some examples, the finger distal ends of each lamp-mounting clip have an inwardly facing catch for engaging an underside surface of the grow lamp retained by the lamp-mounting clip.

In some examples, the bracket body has a body lower surface opposite the body upper surface, the proximal finger ends of each lamp-mounting clip being affixed to the body lower surface.

In some examples, the body lower surface includes at least one recess extending towards the body upper surface, each recess being bounded at least in part by recess sidewalls and a recess end wall extending between the recess sidewalls, the proximal finger ends of each lamp-mounting clip being affixed to the recess end wall of a respective one of the at least one recess.

In some examples, each of the first and second fingers have a finger outer surface directed toward a respective one of the recess sidewalls, the finger outer surface being spaced apart from the respective sidewall when in the laterally inward position.

In some examples, the finger outer surface abuts the respective recess sidewall when in the laterally outward position.

In some examples, each lamp-mounting clip is separately attachable to the bracket body below the body upper surface.

In some examples, the bracket body includes a body upper flange, a body lower flange and a body web between the upper and lower flanges, the body web including a plurality of ribs spaced apart lengthwise along the bracket body, each rib extending between the body upper flange and the body lower flange, each rib having a rib first half on a web first side of the body web and a rib second half on a web second side of the body web.

In some examples, the body upper flange has the body upper surface.

In some examples, each lamp-mounting clip is separately attachable to the body lower flange between adjacent ribs in the plurality of ribs.

In some examples, each lamp-mounting clip includes a resilient mount for releasably securing the lamp-mounting clip to the body lower flange.

In some examples, the resilient mount of each lamp-mounting clip comprises a first arm and a second arm spaced apart from the first arm in a direction perpendicular to a length of the bracket body, the first arm being engageable with the body lower flange on the web first side, and the second arm being engageable with the body lower flange on the web second side.

In some examples, the body distal end includes an upstanding retaining lip.

In some examples, the bracket proximal end includes a mount attachable to the vertical support surface.

In some examples, the body upper surface has an upper surface length between the body proximal end and the body distal end, the upper surface length being sized to accommodate a tray depth of the upper plant tray.

In some examples, the first and second fingers of each lamp-mounting clip form opposing sides of a C-shaped clip.

In another aspect, a kit for a vertical garden is disclosed. The kit includes at least two brackets. Each of the brackets includes a bracket body having a body proximal end attachable to a vertical support surface, and a body distal end spaced apart from the body proximal end. The bracket body has a body upper surface extending lengthwise between the body proximal end and the body distal end for supporting a plant tray. The bracket further includes at least one lamp-mounting clip affixed to the bracket body. Each of the lamp-mounting clips includes a first finger and a second finger spaced apart from the first finger lengthwise along the bracket body. The first and second fingers are directed away from the body upper surface. The kit further comprises a grow lamp retainable by respective ones of the lamp-mounting clips of each bracket.

In some examples, the kit includes a shelf positionable between the plant tray and the body upper surfaces of the at least two brackets when the at least two brackets are mounted to the vertical support surface in a horizontally spaced apart relation.

In some examples, the body upper surface of each bracket has an upper surface length between the body proximal end and the body distal end, the upper surface length being sized to accommodate a shelf depth of the shelf.

In another aspect, a vertical garden assembly is disclosed. The vertical garden assembly comprises a vertical support surface including a first mounting aperture and a second mounting aperture spaced vertically below the first mounting aperture. The vertical garden assembly further comprises a set of first brackets mounted to the first mounting aperture in horizontally spaced apart relation. The vertical garden assembly further comprises a set of second brackets mounted to the second mounting aperture in horizontally spaced apart relation. Each of the first and second brackets include a bracket body having a body proximal end proximate the vertical support surface, and a body distal end spaced apart from the body proximal end. The bracket body has a body upper surface extending lengthwise between the body proximal end and the body distal end. The bracket body includes a bracket mount affixed to the body proximal end. Each of the first and second brackets further include at least one lamp-mounting clip affixed to the bracket body and directed away from the body upper surface. The vertical garden assembly further comprises a first plant tray having a first tray weight supported by the first brackets. The vertical garden assembly further comprises a second plant tray having a second tray weight supported by the second brackets. The vertical garden assembly further comprises a grow lamp extending between and engaged by respective ones of the lamp-mounting clips of each of the first brackets, whereby light emitted from the grow lamp is directed toward the second plant tray.

In some examples, adjacent ones of the first brackets are spaced apart by a first bracket gap and integrally connected to each other by a first platform bridging portion spanning the first bracket gap, and adjacent ones of the second brackets are spaced apart by a second bracket gap and integrally connected to each other by a second platform bridging portion spanning the second bracket gap.

In some examples, the first platform bridging portion supports a portion of the first tray weight between the adjacent ones of the first brackets.

In some examples, the second platform bridging portion supports a portion of the second tray weight between the adjacent ones of the second brackets.

In some examples, each of the first and second platform bridging portions includes a platform proximal end and a platform distal end spaced apart from the platform proximal end. Each of the platform proximal ends includes a platform mount attachable to the vertical support wall.

In some examples, the first platform bridging portion has a platform upper surface, and the platform upper surface of the first platform bridging portion is co-planar with the body upper surfaces of the adjacent ones of the first brackets.

In some examples, the second platform bridging portion has a platform upper surface, and the platform upper surface of the second platform bridging portion is co-planar with the body upper surfaces of the adjacent ones of the second brackets.

In some examples, each of the lamp-mounting clips includes a first finger and a second finger spaced apart from the first finger lengthwise along the bracket body.

In another aspect, a plant tray support apparatus attachable to a vertical support surface between an upper plant tray and a lower plant tray is disclosed. The support apparatus comprises a platform having a platform proximal end and a platform distal end spaced apart from the platform proximal end. The platform has a platform upper surface extending lengthwise between the platform proximal end and the platform distal end for supporting a weight of the upper plant tray. The platform has a platform lower surface opposite the platform upper surface, and a plurality of lamp-mounting clips affixed to the platform lower surface. Each of the lamp-mounting clips includes a first finger and a second finger spaced apart from the first finger lengthwise along the platform to retain a grow lamp between the first and second fingers and beneath the platform upper surface. The support apparatus further comprises a first bracket and a second bracket spaced laterally apart from the first bracket to support the platform. The first and second brackets are laterally spaced apart by a bracket gap and integrally connected to each other by a platform bridging portion of the platform that spans the bracket gap. The platform and the first and second brackets are of unitary construction.

In some examples, each of the first and second brackets comprises a bracket body extending between the platform proximal end and the platform distal end.

In some examples, the platform proximal end includes a platform mount attachable to the vertical support wall.

In some examples, the body proximal end of each of the first and second brackets includes a bracket mount. The platform mount is formed at least in part by the bracket mounts of the first and second brackets.

In some examples, the platform includes a first outboard portion integrally formed with and extending laterally from the bracket body of the first bracket to increase a width of the platform.

In some examples, the platform further includes a second outboard portion integrally formed with and extending laterally from the bracket body of the second bracket to further increase the width of the platform.

Other aspects and features of the teachings disclosed herein will become apparent to those ordinarily skilled in the art, upon review of the following description of the specific examples of the present disclosure.

### DRAWINGS

The drawings included herewith are for illustrating various examples of apparatuses and methods of the present disclosure and are not intended to limit the scope of what is taught in any way. In the drawings:

FIG. 1A is a perspective view of an example bracket according to aspects of the teaching disclosed herein;

FIG. 1B is a side view of the bracket of FIG. 1A;

FIG. 1C is a cross-sectional view of the bracket of FIG. 1B taken along line 1C-1C;

FIG. 2 is a partial perspective view of an example vertical garden assembly including multiple brackets of FIG. 1A;

FIG. 3 is an enlarged view of a portion of the vertical garden assembly identified at box 3 of FIG. 2;

FIG. 4A is a perspective view of another example bracket according to aspects of the teaching disclosed herein;

FIG. 4B is a side view of the bracket of FIG. 4A;

FIG. 4C is a cross-sectional view of the bracket of FIG. 4B taken along line 4C-4C;

FIG. 5 is a schematic illustration of an example kit for a vertical garden, with the kit including two of the brackets of FIG. 1A and a grow lamp;

FIG. 6A is a bottom perspective view of a plant tray support apparatus according to aspects of the teaching disclosed herein;

FIG. 6B is a bottom view of the support apparatus of FIG. 6A;

FIG. 6C is front view of the support apparatus of FIG. 6A;

FIG. 6D is a cross-sectional view of the support apparatus of FIG. 6B taken along lines 6D-6D; and

FIG. 7 is a schematic illustration of an example kit for a vertical garden, with the kit including the support apparatus of FIG. 6A and a grow lamp.

Further aspects and features of the example embodiments described herein will appear from the following description taken together with the accompanying drawings.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

Indoor agricultural and horticultural operations in which plants (e.g., cannabis, orchids, ferns, succulents, etc.) are grown under artificial lighting are rising in popularity. Some advantages of indoor plant growth operations include increased yield per unit area (e.g., vertical framing), allowing for extended growing cycles, fine tuning of environmental variables including light output to enhance plant yield, and enhanced ability to monitor the operation. Vertical gardens, in which there are two or more levels of plants (e.g., one above the other), allow a more efficient use of areal space for a given footprint. Vertical gardens typically include multiple levels of grow lamps.

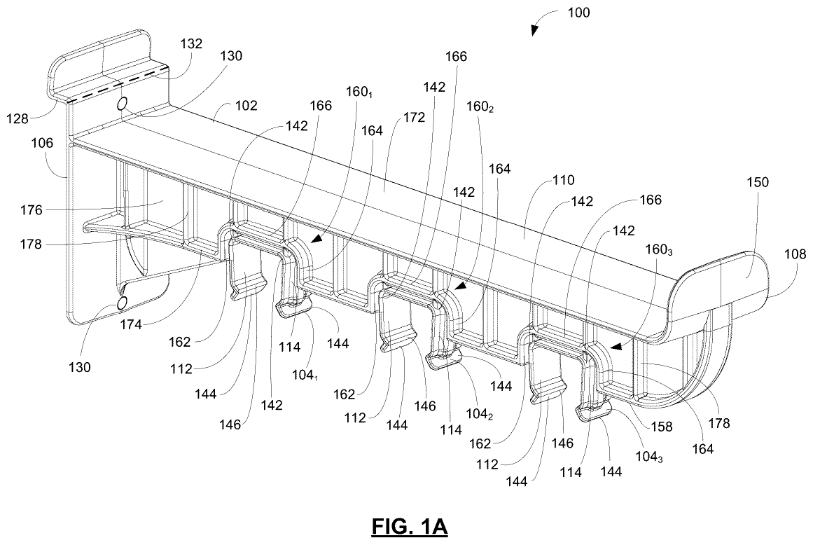

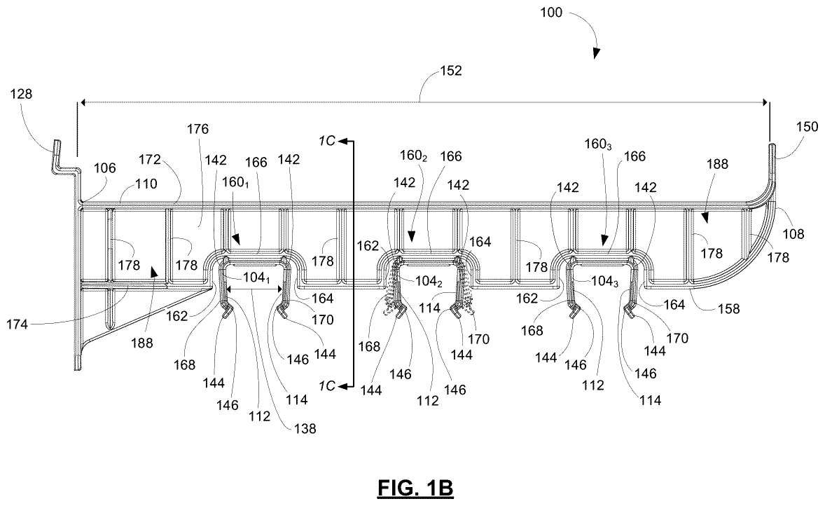

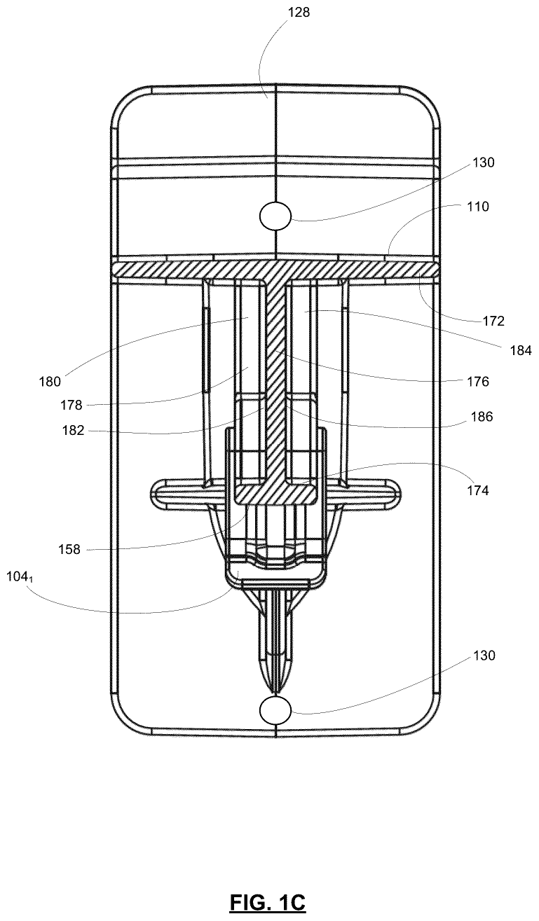

Referring first to FIGS. 1A-1B, a bracket 100 for use in a vertical garden includes a bracket body 102 and at least one mounting clip 104 affixed to the bracket body 102. The bracket body 102 has a body proximal end 106 and a body distal end 108 spaced apart from the body proximal end 106. In the illustrated example, the body proximal end 106 is attachable to a vertical support surface. The bracket body 102 has a body upper surface 110 extending lengthwise between the body proximal end 106 and the body distal end 108 for supporting a plant tray.

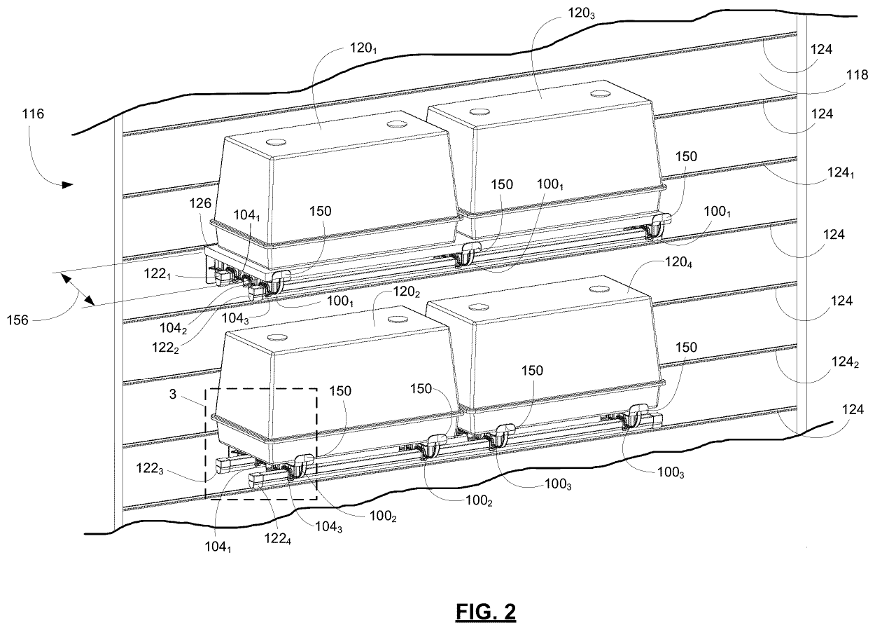

In use (e.g., FIG. 2), the bracket 100 is positioned between an upper plant tray and a lower plant tray. When the body proximal end 106 is attached to a vertical support surface, the body upper surface 110 can support the upper plant tray, and each lamp-mounting clip 104 can retain a grow lamp beneath the body upper surface 110. Light emitted from the retained grow lamp(s) can be directed toward the lower plant tray.

The bracket 100 can include any suitable number of lamp-mounting clips 104. In the illustrated example, the bracket 100 includes three lamp-mounting clips 104₁, 104₂, 104₃ that are spaced apart lengthwise along the bracket body 102. In the illustrated example, the bracket 100 can retain up to three grow lamps (i.e., one grow lamp per lamp-mount clip 104). In other examples, the bracket 100 may include more lamp-mounting clips 104 (e.g., 4 to 10, or more) or fewer lamp-mounting clips 104 (e.g., 1-2). When the bracket 100 includes a plurality of lamp-mounting clips 104, adjacent clips 104 can be equally or unequally spaced apart along the bracket body 102. In the illustrated example, the lamp-mounting clips 104₁, 104₂, 104₃ are equally spaced apart along the bracket body 102.

The body proximal end 106 is attachable to a vertical support surface. The vertical support surface can be any vertical surface capable of supporting a combined weight of multiple brackets 100 and other elements supported by the brackets (e.g., grow lamps, plants trays, and plants). As an example, the vertical support surface may be a wall in a room. As another example, the vertical support surface may include a mounting board that has pre-formed mounting locations (e.g., slots, grooves, etc.) for mating with the body proximal end 106. The mounting board may be secured to a wall in a room. Alternatively, the mounting board may be positioned away from the wall and supported in a vertical orientation by a support structure.

Each lamp-mounting clip 104 includes a first finger 112 and a second finger 114 spaced apart from the first finger 112 lengthwise along the bracket body 102. The first and second fingers 112, 114 are, in the illustrated example, directed away from the body upper surface 110. In the illustrated example, the first and second fingers 112, 114 of each lamp-mounting clip 104 form opposing sides of a C-shaped clip that opens downwardly. One or more grow lamps retained by the lamp-mounting clips 104 will generally, in the illustrated example, direct light toward a plant tray positioned below the bracket 100.

Referring now to FIG. 2, a vertical garden assembly 116 includes a vertical support surface 118 and a plurality of brackets 100 attached to the vertical support surface 118. The vertical garden assembly further includes a plurality of plant trays 120 supported by the brackets 100, and a plurality of grow lamps 122 retained by the brackets 100. In the illustrated example, the plurality of brackets 100 of the vertical garden assembly 116 includes two sets of brackets 100, namely a first set of first brackets 100₁, and a second set of second brackets 100₂. In the illustrated example, the plurality of plant trays 120 of the vertical garden assembly 116 includes a first plant tray 120₁ and a second plant tray 120₂. In the illustrated example, the plurality of grow lamps 122 of the vertical garden assembly 116 includes a first grow lamp 122₁ and a second grow lamp 122₂. The vertical garden assembly 116 illustrated in FIG. 2 is provided as an example for illustrative purposes. The illustrated example is one of many possible arrangements of the vertical garden assembly 116.

In the illustrated example, the vertical support surface 118 includes a plurality of mounting apertures configured for attachment to the bracket 100. Various configurations of mounting apertures are possible. For example, the mounting apertures may be openings in a vertical shelf track. In the illustrated example, the mounting apertures comprise a plurality of mounting slots 124 that extend horizontally across the vertical support surface 118. All else being equal, a vertical support surface 118 with a greater number of mounting apertures provides more locations at which to mount the brackets 100 than a vertical support surface 118 with a lower number of mounting apertures.

The plurality of mounting slots 124 of the vertical support surface 118 include a first mounting slot 124₁ and a second mounting slot 124₂ spaced vertically below the first mounting slot 124₁. In the illustrated example, the first brackets 100₁ are mounted to the first mounting slot 124₁ in horizontally spaced apart relation relative to each other. The first plant tray 120₁ has a weight supported by the body upper surfaces 110 of the first brackets 100₁. The second brackets 100₂ are mounted to the second mounting aperture 124₂ in horizontally spaced apart relation relative to each other. The second plant tray 120₂ has a weight supported by the body upper surfaces 110 of the second brackets 100₂.

In other examples, the vertical support surface 118 does not include mounting apertures. Each bracket 100 of the vertical garden assembly 116 can be secured to the vertical support surface 118 with one or more fasteners (e.g., screws, bolts, nails, etc.) that pass through respective body apertures 130 (FIG. 1A) and into the vertical support surface 118. The first brackets 100₁ can be secured to the vertical support surface 118 at a higher elevation than the second brackets 100₂.

In the illustrated example, the first set of brackets includes three first brackets 100₁. In other examples, the first set of brackets 100 may include more brackets (e.g., 4 to 6, or more) or fewer brackets (e.g., 2). In the illustrated example, the second set of brackets includes two second brackets 100₂. In other examples, the second set of brackets 100 may include more brackets (e.g., 3 to 6, or more). The number of brackets 100 included in the first and second sets of brackets may be selected based on load requirements. All else being equal, a set with a higher number of brackets 100 can support a greater load than a set with a lower number of brackets 100. Further, the set with the higher number of brackets 100 can improve load distribution since more brackets 100 may be spaced apart below the load.

In the illustrated example, the first and second grow lamps 122₁, 122₂ extend transversely between each of the first brackets 100₁ and are engaged by respective lamp-mounting clips 104 of each of the first brackets 100₁. The first grow lamp 122₁ is, in the illustrated example, engaged by the lamp-mounting clips 104₁ of each first bracket 100₁ and the second grow lamp 122₂ is engaged by the lamp-mounting clips 104₃ of each first bracket 100₁. In this arrangement, light emitted by the first and second grow lamps 122₁, 122₂ can be directed toward the second plant tray 120₂ (i.e., the emitted light is directly downwardly at the second plant tray 120₂).

In an alternative example, a single grow lamp 122 may extend transversely between the first brackets 100₁ and be engaged by respective lamp-mounting clips 104 of each of the first brackets 100₁. For example, the single grow lamp 122 may be engaged by the lamp-mounting clips 104₂ (i.e., the middle clip) of each of the first brackets 100₁. In another alternative example, three grow lamps 122 may extend transversely between the first brackets 100₁ and be engaged by respective lamp-mounting clips 104 of each of the first brackets 100₁ (i.e., grow lamps 122 retained in all three clips 104 of each of the first bracket 100₁). The number of grow lamps 122 secured to the clips 104 of the first brackets 100₁ may be based on one or more factors (e.g., the lighting needs of the plant species contained in the second plant tray 120₂, the intensity of each grow lamp 122, vertical spacing between the first and second brackets 100₁, 100₂, power requirements, etc.).

Referring still to FIG. 2, the vertical garden assembly 116 includes a shelf 126 positioned between the first plant tray 120₁ and the body upper surfaces 110 of the first brackets 100₁. The shelf 126 bears against the body upper surfaces 110 of the first brackets 100₁, and the first plant tray 120₁ is supported by the shelf 126. In an alternative example, the vertical garden assembly 116 may also include a shelf 126 positioned between the second plant tray 120₂ and the body upper surfaces 110 of the second brackets 100₂.

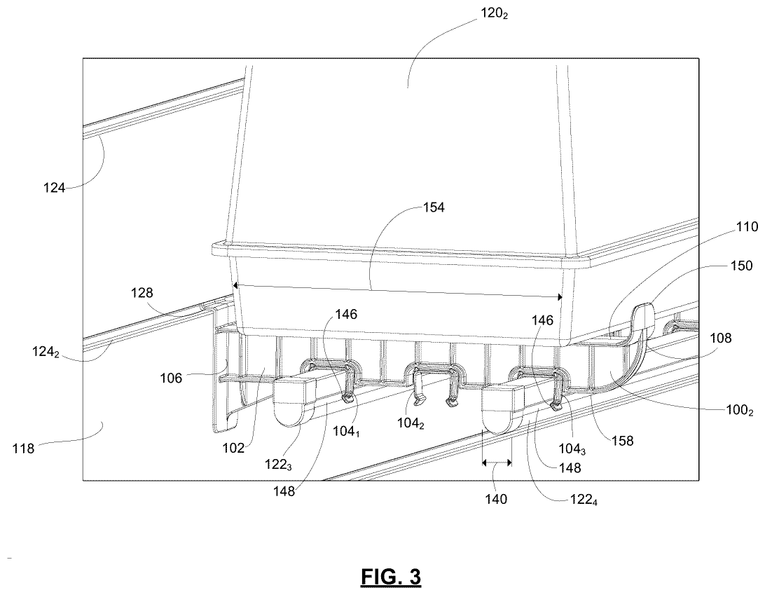

In another alternative example, the vertical garden assembly 116 does not include a shelf 126, and the plant trays 120 bear directly against the body upper surfaces 110 of the respective first and second brackets 100₁, 100₂. For example, FIGS. 2 and 3 show the second plant tray 120₂ bearing directly against the body upper surfaces 110 of the second brackets 100₂.

In the illustrated example, the vertical garden assembly 116 includes an optional third plant tray 120₃. The first and third plant trays 120₁, 120₃ are positioned side-by-side on the shelf 126, and a collective weight of the first and third plant trays 120₁, 120₃ is supported by the body upper surfaces 110 of the first brackets 1001.

In the illustrated example, the vertical garden assembly 116 includes an optional third set of third brackets 100₃ and an optional fourth plant tray 120₄. Each of the third brackets 100₃ are the same as the bracket 100 described above with reference to FIGS. 1A-1B. Like the second brackets 100₂, the third brackets 100₃ are mounted to the second mounting slot 124₂ in horizontally spaced apart relation relative to each other. In the illustrated example, the third set of brackets includes 2 third brackets 100₃. In other examples, the third set of brackets may include more brackets (e.g., 3 to 6, or more). Like the first and second sets of brackets, the number of brackets 100 included in the third set of brackets may be selected based on load requirements.

The fourth plant tray 120₄ has a weight supported by the body upper surfaces 110 of the third brackets 100₃. The second and fourth plant trays 120₂, 120₄ are arranged side-by-side and below the first and second grow lamps 122₁, 122₂. In this arrangement, light emitted by the first and second grow lamps 122₁, 122₂ can be directed toward both the second and fourth plant trays 120₂, 120₄.

In the illustrated example, the vertical garden assembly 116 includes third and fourth grow lamps 122₃, 122₄ that extend transversely between all four of the second and third brackets 100₂, 100₃ and are engaged by respective lamp-mounting clips 104 of each of the second and third brackets 100₂, 100₃. The third grow lamp 122₃ is engaged by the lamp-mounting clips 104₁ of each of the second and third brackets 100₂, 100₃ and the fourth grow lamp 122₄ is engaged by the lamp-mounting clips 104₃ of each of the second and third brackets 100₂, 100₃. In this arrangement, light emitted from the grow lamps 122₃, 122₄ can be directed toward a plant tray (not shown) positioned below the second and third brackets 100₂, 100₃. In cases where no plant trays are positioned below a particular set of brackets 100, the clips 104 of those brackets 100 can be left empty (i.e., there is no need for one or more grow lamps if there is no plant tray below).

Referring again to FIGS. 1A-1B, the body proximal end 106 can be configured for attachment to a vertical support surface in any suitable fashion. For example, the body proximal end 106 can be rigidly connected to a vertical support surface with adhesives, mechanical fasteners, or a combination thereof. In the illustrated example, the body proximal end 106 includes a mount 128. In the illustrated example, the vertical support surface 118 (FIG. 2) comprises a slat wall with apertures in the form of horizontal channels. The mount 128 is configured to interlock with the mounting slots 124 (e.g., horizontally extending channels).

In other examples, the mount 128 can be removed and the body proximal end 106 secured to a vertical support surface with one or more fasteners that pass through respective body apertures 130 and into the vertical support surface. In the illustrated example, the mount 128 may be broken away from the body proximal end 106 along separation line 132 (shown in broken lines in FIG. 1A). In other examples, the body proximal end 106 includes one of more body apertures 130 and does not include the mount 128.

Referring again to FIGS. 1A-1B, the first and second fingers 112, 114 of each lamp-mounting clip 104 cooperate to retain a grow lamp therebetween. In the illustrated example, the first and second fingers 112, 114 of each lamp-mounting clip 104 are resiliently flexible for movement between laterally inward and outward positions. Each of the first and second fingers 112, 114 is biased to the laterally inward position.

When each of the first and second fingers 112, 114 are in the laterally inward position (shown in solid lines in FIG. 1B), the first and second fingers 112, 114 are spaced apart by a finger gap 138. The finger gap 138 is slightly smaller than a lamp width 140 (FIG. 3) of the grow lamp 122. Accordingly, when the grow lamp 122 is received between opposed first and second fingers 112, 114, each of the first and second fingers 112, 114 is urged toward the laterally outward position (shown in broken lines in FIG. 1B), against a biasing force urging each of the first and second fingers 112, 114 to the laterally inward position. The first and second fingers 112, 114 apply opposed holding forces to the installed grow lamp 122 as a result of the biasing force urging the fingers toward the laterally inward positions. In other examples, the first and second fingers 112, 114 are not resiliently flexible.

Referring to FIGS. 1A-1B, the first and second fingers 112, 114 extend downwardly from a finger proximal end 142 to a finger distal end 144. The finger distal ends 144 each have an optional inwardly facing catch 146. In the illustrated example, the inwardly facing catches 146 engage an underside surface 148 of the grow lamp 122 received between the fingers of the lamp-mounting clip 104. The inwardly facing catches 146 further ensure retention of the grow lamps 122 by the lamp-mounting clips 104, and may inhibit unintended disengagement of the grow lamp 122 from the lamp-mounting clip 104.

Referring again to FIGS. 1A-1B, the body distal end 108 includes an optional upstanding retaining lip 150. The upstanding retaining lip 150 may avert unintended dislodgment of the plant tray 120 (e.g., FIG. 3) from the body upper surface 110. Alternatively, or in addition, the upstanding retaining lip 150 may avert unintended dislodgment of the shelf 126 (e.g., FIG. 2) from the brackets 100.

Referring to FIG. 1B, the body upper surface 110 has an upper surface length 152 between the body proximal end 106 and the body distal end 108. In the illustrated example, the upper surface length 152 extends from the upstanding retaining lip 150 to the mount 128. The upper surface length 152 is, in the illustrated example, sized to accommodate a tray depth 154 of the plant tray 120. With reference to FIGS. 1B and 2, the upper surface length 152 is, in the illustrated example, also sized to accommodate a shelf depth 156 of the shelf 126.

Referring again to FIGS. 1A-1B, the bracket body 102 has a body lower surface 158 opposite the body upper surface 110. The proximal finger ends 142 of each lamp-mounting clip 104 are affixed to the body lower surface 158. In the illustrated example, the bracket body 102 and the lamp-mounting clips 104 are of unitary construction. The unitary construction of the bracket body 102 and the lamp-mounting clip 104 can provide advantages, such as, for example, simplified construction (i.e., no need to manufacture two distinct parts), and/or simplified use of the bracket 100 (e.g., the clips 104 cannot be misplaced, attached incorrectly to the bracket body 102, etc.).

In the illustrated example, the body lower surface 158 includes an upwardly extending recess 160 for each of the lamp-mounting clips 104. In the illustrated example, the bracket 100 includes three lamp-mounting clips 104₁, 104₂, 104₃, and the body lower surface 158 includes three corresponding recesses 160₁, 160₂, 160₃. Each recess 160 extends toward the body upper surface 110. Referring to FIG. 1B, each recess 160 is bounded at least in part by recess sidewalls 162, 164 and a recess end wall 166 extending between the upper (inner) ends of recess sidewalls 162, 164. The proximal finger ends 142 of each lamp-mounting clip 104 are, in the illustrated example, affixed to the recess end wall 166 of the corresponding recess 160.

Referring to FIG. 1B, the first finger 112 of each lamp-mounting clip 104 has a first finger outer surface 168 directed toward the recess sidewall 162. The second finger 114 of each lamp-mounting clip 104 has a second finger outer surface 170 directed toward the recess sidewall 164. The first and second finger outer surfaces 168, 170 are spaced apart from the respective sidewalls 162, 164 when in the laterally inward position. Considering, for example, the lamp-mounting clip 104₂ in FIG. 1B, the first and second finger outer surfaces 168, 170 abut respective recess sidewalls 162, 164 when in the laterally outward position. Such an arrangement may prevent the first and second finger 112, 114 from “over-flexing”, and thereby limit breakages of each lamp-mounting clip 104.

Referring to FIGS. 1A-1C, the bracket body 102 includes a body upper flange 172, a body lower flange 174 and an optional body web 176 between the upper and lower flanges 172, 174. The body upper flange 172 and the body lower flange 174 are generally horizontal, and the body web 176 extends generally vertically between the flanges, with the bracket body having a generally “I” shaped cross-section. In the illustrated example, the body upper surface 110 includes an upper surface of the body upper flange 172 and the body lower surface 158 includes a bottom surface of the body lower flange 174. In the illustrated example, the body upper flange 172 is wider than the body lower flange 174. The enlarged body upper flange 172 increases the amount of “surface-to-surface” contact between the body upper surface 110 and the plant tray 120 or shelf 126 (whichever one is seated on the body upper surface 110).

The bracket body 102 further includes a plurality of optional ribs 178 extending vertically between the flanges 172, 174 and spaced apart from each other lengthwise along bracket body 102. Each rib 178 extends between the body upper flange 172 and the body lower flange 174. In the example illustrated, as shown in FIG. 1C, each rib 178 has a rib first half 180 on a web first side 182 of the body web 176 and a rib second half 184 on a web second side 186 of the body web 176. The ribs 178 improve structural rigidity and load bearing capacity of the brackets 100. Alternative configurations of the bracket body 102 are possible, for example, the bracket body 102 may have a rectangular cross-section (instead of the “I” shaped cross-section shown).

In the illustrated example, the ribs 178 define a plurality of body recesses 188 (shown in FIG. 1B). Each body recess 188 is bounded by the body web 176, adjacent ribs 178, and the body upper and lower flanges 172, 174. In other examples, the ribs 178 may define a plurality of body void regions (i.e., instead of the body recesses 188). Each body void region may be bounded by adjacent ribs 178 and the body upper and lower flanges 172, 174. For example, space extending lengthwise between one or more adjacent pairs of ribs 178 and vertically between the flanges 172, 174 may be free of any web 176. The inclusion of void spaces along the length of the bracket body 102 may reduce the weight and/or material cost of the bracket body 102 without lowering its structural rigidity and load bearing capacity.

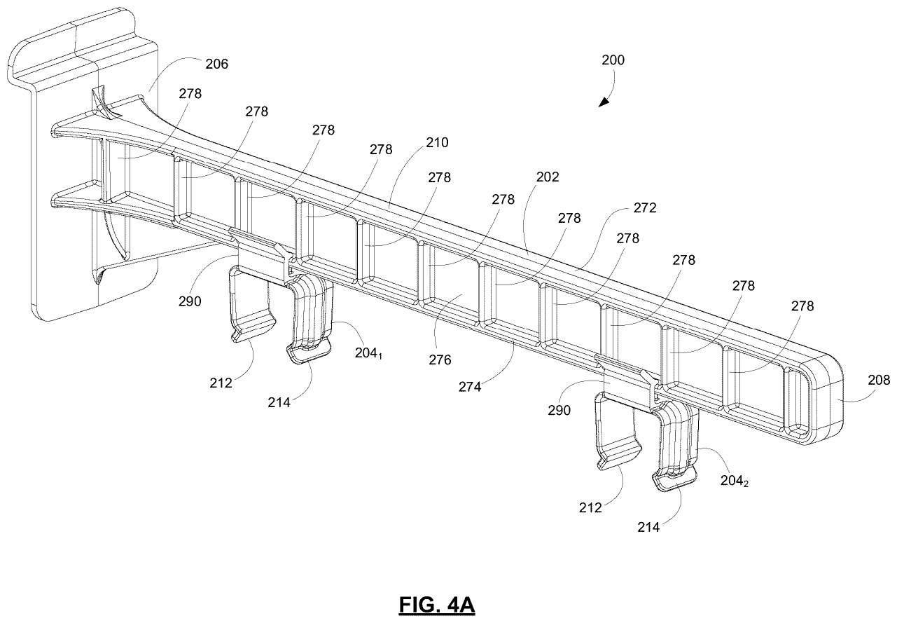

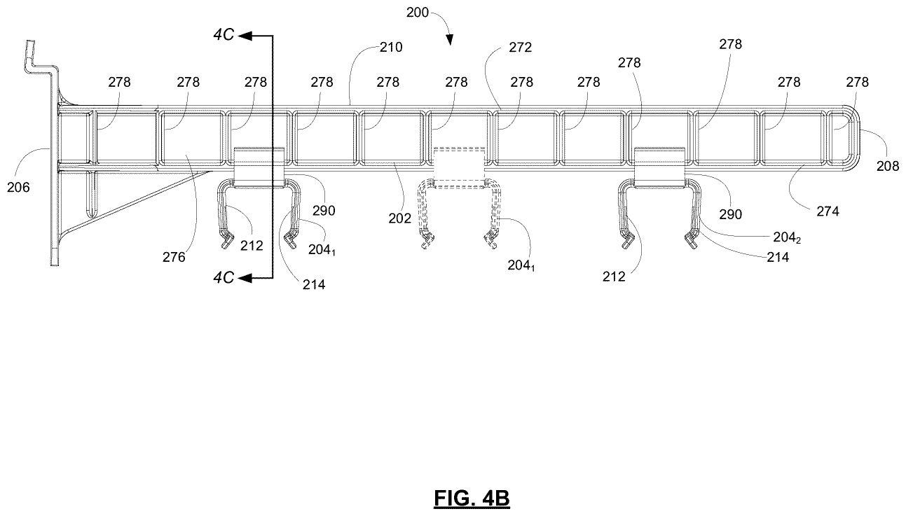

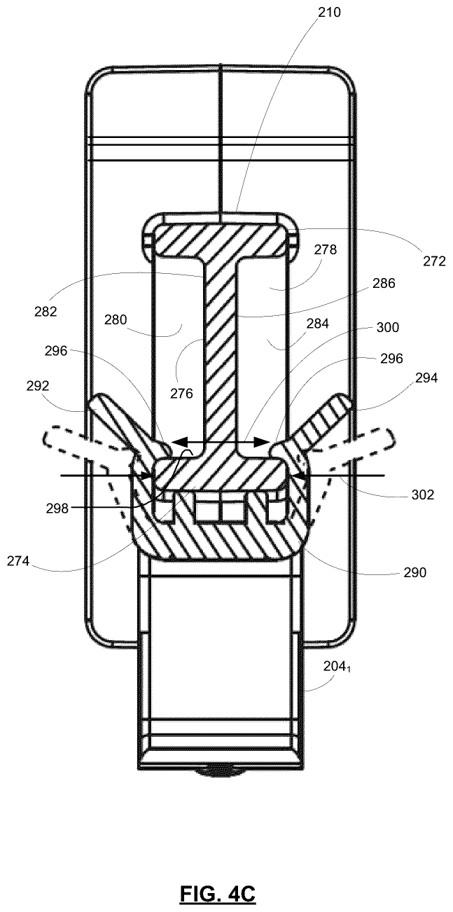

Referring now to FIGS. 4A-4B, another example of a bracket 200 is similar to the bracket 100 shown in FIGS. 1A-1B and elements of bracket 200 having similar structure and/or performing similar function as those in the bracket 100 are identified with similar reference characters, incremented by 100.

In the illustrated example, the bracket 200 includes a bracket body 202 having a body upper flange 272, a body lower flange 274, and a plurality of ribs 278 spaced apart lengthwise along bracket body 202 and extending vertically between the upper and lower flanges 272, 274. An optional body web 276 can extend lengthwise between one or more adjacent pairs of ribs, and vertically between the body upper flange 272 and the body lower flange 274. In the example illustrated, as shown in FIG. 4C, each rib 278 has a rib first half 280 on a body first side 282 of the body 202 and a rib second half 284 on a body second side 286 of the body 202. The body upper flange 272, the body lower flange 274 and the body web 276 give the bracket body an “I” shape cross-section.

In the illustrated example, the bracket 200 includes two lamp-mounting clips 204₁ and 204₂ that are separately attachable to the bracket body 202 below the body upper surface 210. Each lamp-mounting clip 204 can retain a grow lamp beneath the body upper surface 210. Light emitted from the retained grow lamp(s) can be directed toward one or more plant trays below the bracket 200. The first and second fingers 212, 214 of each lamp-mounting clip 204 cooperate to retain a grow lamp therebetween.

In the illustrated example, each lamp-mounting clip 204 is separately attachable to the body lower flange 274 between adjacent ribs 278 of the plurality of ribs 278. The lamp-mounting clip 204₁ is attachable to the body lower flange 274 in any one of a plurality of positions (see. FIG. 4B). A user can select the number and position of lamp-mounting clips 204 attached to the bracket body 202. As an example, the user may choose to attach only one lamp-mounting clip 204 to bracket body 202 about midway between the body proximal end 206 and body distal end 208. As another example, the user may choose to attach four evenly spaced apart lamp-mounting clips 204 to the bracket body 202. Many other configurations are possible.

Each lamp-mounting clip 204 can be releasably secured to the bracket body 202 in any suitable manner. The lamp-mounting clips 204 can be releasably secured to the bracket body 202 with adhesives, mechanical fasteners, or a combination thereof. In the illustrated example, each lamp-mounting clip 204 includes a resilient mount 290 for releasably securing the lamp-mounting clip 204 to the body lower flange 274. Referring to FIG. 4C, in the illustrated example, the resilient mount 290 of each lamp-mounting clip 204 includes a first arm 292 and a second arm 294 spaced apart from the first arm 292 in a direction perpendicular to a length of the bracket body 202. The first arm 292 is engageable with the body lower flange 274 on the body first side 282 of the body 202. The second arm 294 is engageable with the body lower flange 274 on the body second side 286 of the body 202.

The first and second arms 292, 294 cooperate to retain the body lower flange 274 therebetween. Referring to FIG. 4C, in the illustrated example, the first and second arms 292 and 294 are resiliently flexible between laterally inward (arms in solid lines) and outward positions (arms in broken lines). Each of the first and second arms 292, 294 is biased to the laterally inward position.

In the illustrated example, each of the first and second arms 292, 294 have an inwardly facing protrusion 296. When the resilient mount 290 is secured to the body lower flange 274, the inwardly facing protrusions 296 engage an upperside surface 298 of the body lower flange 274. The inwardly facing protrusions 296 can help to secure the lamp-mounting clip 204 to the body lower flange 274 and inhibit unintended disengagement of the resilient mount 290 from the body lower flange 274.

When each of the first and second arms 292, 294 are in the laterally inward position, the inwardly facing protrusions 296 are spaced apart by a protrusion gap 300. The protrusion gap 300 is slightly smaller than a flange width 302 of body lower flange 274. Consequently, as the body lower flange 274 is received between opposed protrusions 296, each of the first and second arms 292, 294 is urged toward the laterally outward position, against a biasing force urging each of the first and second arms 292, 294 to the laterally inward position. Once fully installed, the first and second arms 292, 294 return to (or near to) their laterally inward positions. A user can urge the first and second arms 292, 294 to their laterally outward positions to detach that lamp-mounting clip 204 from the bracket body 202.

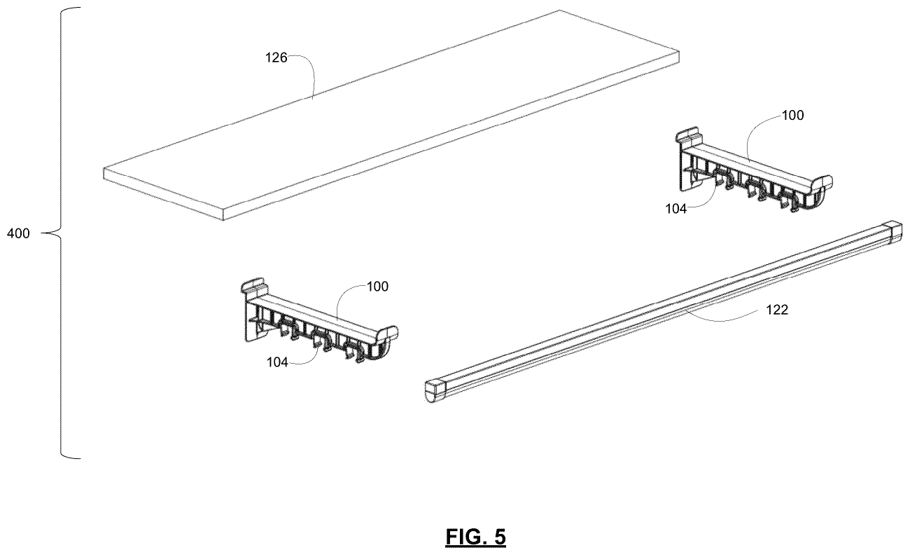

Referring now to FIG. 5, a kit 400 for a vertical garden includes two brackets 100 and a grow lamp 122. The lamp-mounting clips 104 of the brackets 100 are sized to accommodate the grow lamp 122. In some examples, the kit 400 includes an optional shelf 126. The shelf 126 is positionable between a plant tray and the body upper surfaces 110 of the brackets 100 when the brackets 100 are mounted to a vertical support surface in horizontally spaced apart relation to each other (e.g., see FIG. 3).

In some examples, the kit 400 includes more than two brackets 100 (e.g., 3-20 brackets). In some examples, the kit 400 includes multiple of any one or more of the grow lamp 122 and the shelf 126. As an example, the kit 400 may include four brackets 100, two grow lamps 122 and one shelf 126. As another example, the kit 400 may include six brackets 100, and three grow lamps 122. As yet another example, the kit 400 may include ten brackets 100, four grow lamps 122 and two shelves 126. In an alternative example, the bracket 100 in the kit 400 may be replaced with the bracket 200.

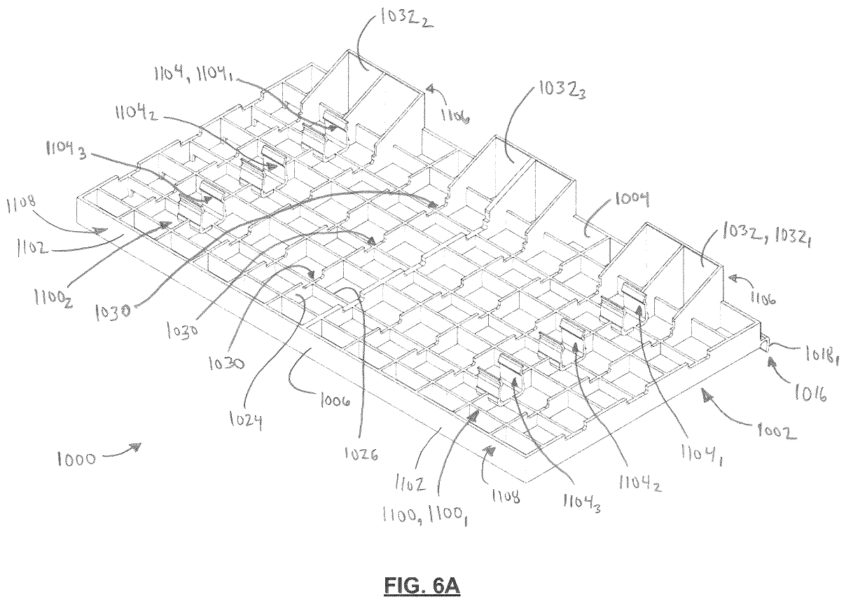

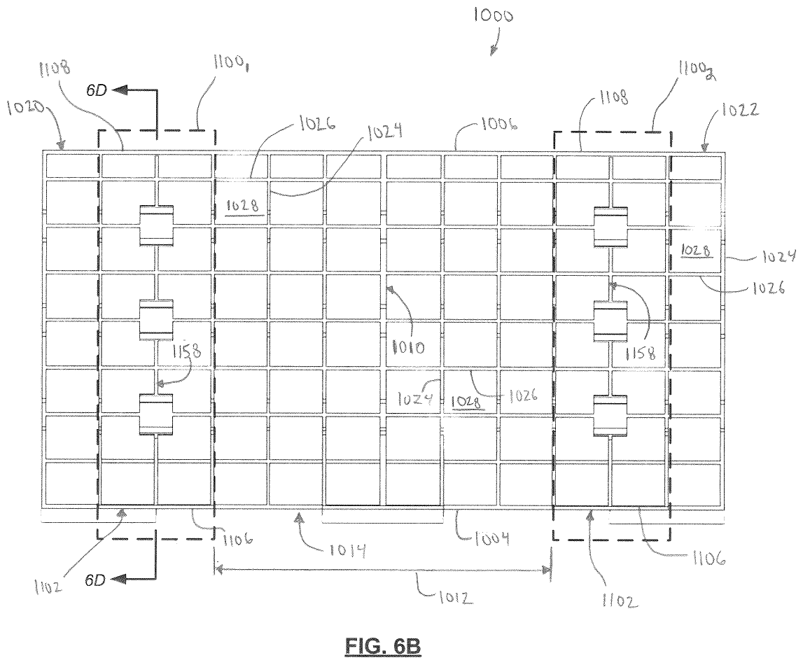

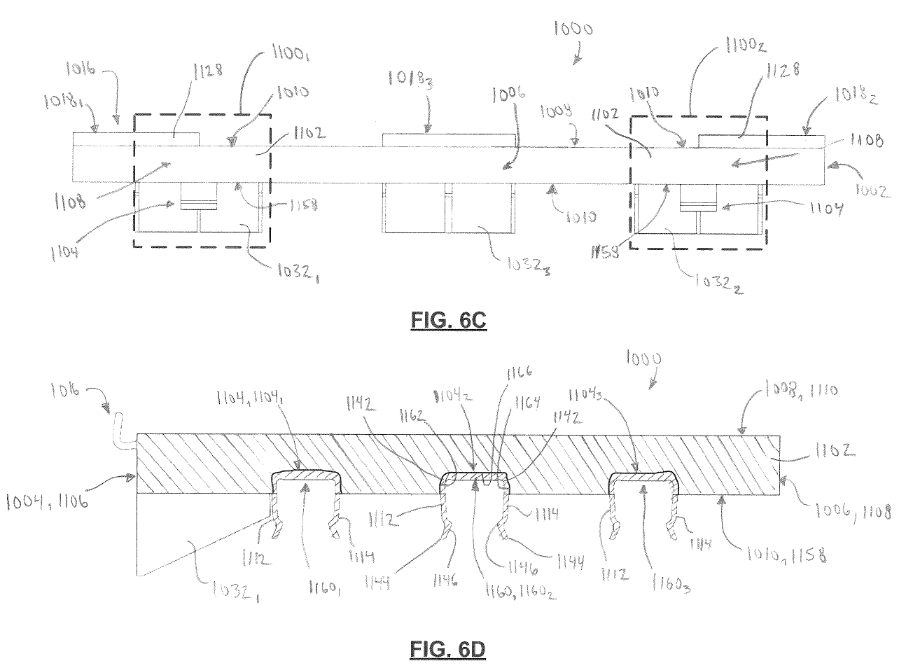

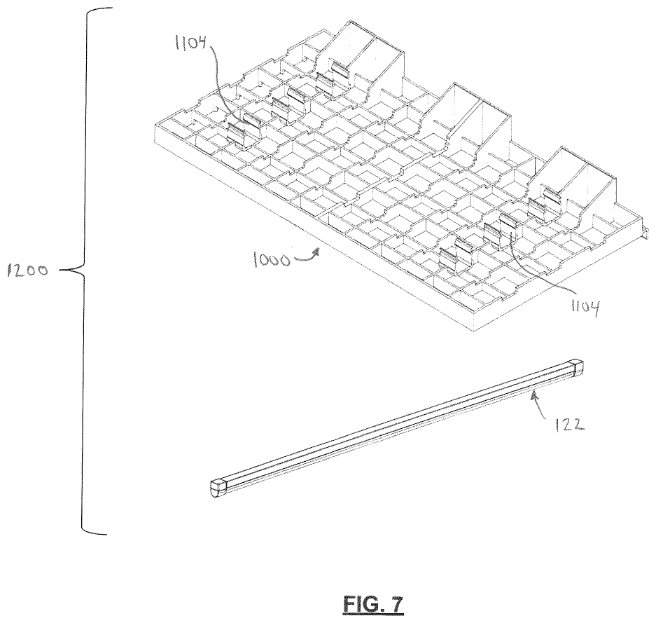

Referring now to FIGS. 6A-6D, a plant tray support apparatus 1000 for use in a vertical garden includes a platform 1002, a first bracket 1100₁ and a second bracket 1100₂ laterally spaced apart from the first bracket 1100₁. The brackets 1100₁, 1100₂ have some similarity to the bracket 100, with like features identified by like reference characters, incremented by 1000. As will be discussed subsequently herein, the laterally spaced apart brackets 1100 can assist in mounting the support apparatus 1000 to a vertical support surface and/or provide structural support to the platform 1002 to withstand load during use.

The platform 1002 has a platform proximal end 1004 and a platform distal end 1006 spaced apart from the platform proximal end 1004. With reference to FIGS. 6C and 6D, the platform 1002 has a platform upper surface 1008 extending lengthwise between the platform proximal end 1004 and the platform distal end 1006 for supporting a plant tray. The platform also has a platform lower surface 1010 opposite the platform upper surface 1008, and a plurality of lamp-mounting clips 1104 affixed to the platform lower surface 1010.

In use, the support apparatus 1000 is attached to a vertical support surface (e.g., see vertical support surface 118 in FIG. 2) between an upper plant tray and a lower plant tray. When the support apparatus 1000 is attached to the vertical support surface, the platform 1002 provides a generally horizontal surface for supporting the upper plant tray. In the example illustrated, the plant tray bears directly on the platform upper surface 1008. Alternatively, an additional support member, such as a shelf, can be positioned between the platform upper surface 1008 of the platform 1002 and the plant tray. Further, each lamp-mounting clip 1104 is configured to retain a grow lamp beneath the platform upper surface 1008. Light emitted from the retained grow lamp(s) can be directed toward the lower plant tray.

The platform proximal end 1004 can be configured for attachment to a vertical support surface in any suitable fashion. For example, the platform proximal end 1004 can be rigidly connected to a vertical support surface with adhesives, mechanical fasteners, or a combination thereof. In the illustrated example, with reference to FIGS. 6A, 6C and 6D, the platform proximal end 1004 includes a platform mount 1016 which is configured to interlock with mounting slots of a slat wall (e.g., see mounting slots 124 in FIG. 3). Referring to FIG. 6C, in the illustrated example, the platform mount 1016 comprises three laterally spaced apart platform mounting portions 1018₁, 1018₂, 1018₃. In the example illustrated, the platform mounting portions 1018₁, 1018₂ are positioned adjacent respective lateral ends of the platform 1002 and the platform mounting portion 1018₃ is positioned at the center of platform 1002. In some examples, the platform mount 1016 does not include the central platform mounting portion 1018₃.

Referring to FIG. 6B, the first and second brackets 1100₁, 1100₂ are laterally spaced apart by a bracket gap 1012 and integrally connected to each other by a platform bridging portion 1014 of the platform 1002 that spans the bracket gap 1012. In use, the platform bridging portion 1014 distributes load to the brackets 1100.

In the illustrated example, the platform 1002 and the first and second brackets 1100₁, 1100₂ are of unitary construction. Having the platform 1002 integrally formed with the first and second brackets 1100₁, 1100₂ can provide one or more advantages for the support apparatus 1000. For example, installing the support apparatus 1000 on a vertical support wall is simplified since only a single (i.e., one-piece) structure needs to be attached to the vertical support wall. If multiple, separate, support brackets were used instead of the support apparatus 1000, an installer would need to vertically align each of the brackets when attaching them to the vertical support surface to ensure the shelf and/or plant tray positioned on the brackets does not slope to one side. Alternatively, or in addition, using the support apparatus 1000 may avoid the need of a separate shelf all together. One or more plant trays can be placed directly on the platform upper surface 1008 of the support apparatus 1000. In some examples, if desired, a user can still choose to position a shelf on the platform upper surface 1008 prior to placement of the plant tray(s).

With reference to FIGS. 6B and 6C, each bracket 1100 includes a bracket body 1102 having a body proximal end 1106, a body distal end 1108, a body upper surface 1110, and a body lower surface 1158. The body upper surfaces 1110 of the respective brackets 1100, in the illustrated example, are co-planar with the platform upper surface 1008. When the support apparatus 1000 is attached to a vertical support surface, each bracket body 1102 extends longitudinally from the body proximal end 1106 (located proximate the vertical support surface) to the body distal end 1108.

Referring to FIG. 6C, in the example illustrated, the platform upper surface 1008 is formed at least in part by the body upper surfaces 1110 of the first and second brackets 11001, 11002.

Referring again to FIGS. 6B and 6C, in the illustrated example, the body upper surface 1110 and the body lower surface 1158 of each bracket 1100, extend between the platform proximal end 1004 and the platform distal end 1006. In the illustrated example, the platform proximal end 1004 comprises the body proximal ends 1106 of the respective first and second brackets 1100₁, 1100₂. Similarly, the platform distal end 1006, in the illustrated example, comprises the body distal ends 1108 of the respective first and second brackets 1100₁, 1100₂.

In the illustrated example, with reference to FIG. 6C, the body proximal ends 1106 of each bracket 1100 include a bracket mount 1128. In some examples, the bracket mount 1128 may be aligned longitudinally with bracket body 1102 (in which case, for example, a longitudinal axis extending along the bracket body 1102 from the body distal end 1108 to the body proximal end 1106 intersects the bracket mount 1128). In the example illustrated, the bracket mount 1128 is laterally offset from the bracket body 1102.

Referring still to FIG. 6C, the platform mount 1016 is, in the illustrated example, formed at least in part by the bracket mounts 1128 of the first and second brackets 1100₁, 1100₂. In the illustrated example, the platform mounting portion 1018₁ is formed in part by the bracket mount 1128 of the first bracket 1100₁ and the platform mounting portion 1018₃ is formed in part by the bracket mount 1128 of the second bracket 1100₂. In an alternative example, the platform mount 1128 may be formed entirely by the bracket mounts 1128 of the respective brackets 1100.

In use, the platform 1002 distributes load to the laterally spaced apart brackets 1100₁, 1100₂ which can help to prevent the platform 1002 from sagging under the weight of the plant tray. In other examples, the support apparatus 1000 may include more brackets 1100 (e.g., 3 to 6, or more). The number of brackets 1100 included in the support apparatus 1000 may be selected based on load requirements. All else being equal, a support apparatus with a higher number of brackets 1100 can support a greater load than a support apparatus with a lower number of brackets 1100. Further, a support apparatus with the higher number of brackets 1100 can improve load distribution across the platform 1002 since more brackets 1100 may be spaced apart below the load.

Referring to FIGS. 6A and 6D, the support apparatus 1000 includes optional gussets 1032 proximate the platform proximal end 1004. When the support apparatus 1000 is attached to a vertical support surface, the rearward face of each gusset 1032 abuts the vertical support surface to enhance stability of the engagement between the vertical support wall and the support apparatus 1000. In the illustrated example, the support apparatus 1000 includes three gussets 1032₁, 1032₂, 1032₃ that are laterally spaced apart along the platform proximal end 1004. In the example illustrated, the gussets 1032₁, 1032₂ are positioned adjacent respective lateral ends of the platform 1002 and the gusset 1032₃ is positioned at the center of platform 1002. In some examples, the support apparatus 1000 does not include the central gusset 1032₃.

In the illustrated example, the gusset 1032₁ is formed by the body proximal end 1106 of the first bracket 1100₁. The gusset 1032₂ is, in the example illustrated, formed by the body proximal end 1106 of the second bracket 1100₂. In an alternative example, one or more of the gussets 1032 may be formed partially by a corresponding one of body proximal ends 1106.

The support apparatus 1000 can include any suitable number of lamp-mounting clips 1104. In the illustrated example, six lamp-mounting clips 1104 are affixed to the platform lower surface 1010. In other examples, the support apparatus 1000 may include more lamp-mounting clips 1104 (e.g., 7 to 18, or more) or fewer lamp-mounting clips 104 (e.g., 1 to 5). In the illustrated example, the lamp-mounting clips 1104 are integrally formed with the brackets 1100 and the platform 1002. The unitary construction of the platform 1002, brackets 1100 and the lamp-mounting clip 1104 can provide advantages, such as, for example, simplified construction (i.e., no need to manufacture distinct parts), and/or simplified use of the support apparatus 1000 (e.g., the clips 1104 cannot be misplaced, attached incorrectly, etc.).

Referring to FIG. 6C, each lamp-mounting clip 1104 includes a first finger 1112 and a second finger 1114 spaced apart from the first finger 1112 lengthwise along the bracket body 1102. The first and second fingers 1112, 1114 are, in the illustrated example, directed away from the platform upper surface 1008. One or more grow lamps retained by the lamp-mounting clips 1104 will generally, in the illustrated example, direct light toward a plant tray positioned below the support apparatus 1000.

The first and second fingers 1112, 1114 of each lamp-mounting clip 1104 cooperate to retain a grow lamp therebetween. In the illustrated example, the first and second fingers 1112, 1114 of each lamp-mounting clip 1104 are resiliently flexible for movement between laterally inward and outward positions. Each of the first and second fingers 1112, 1114 is biased to the laterally inward position. Accordingly, when a grow lamp is received between opposed first and second fingers 1112, 1114, each of the first and second fingers 1112, 1114 is urged toward the laterally outward position, against a biasing force urging each of the first and second fingers 1112, 1114 to the laterally inward position. The first and second fingers 1112, 1114 apply opposed holding forces to the installed grow lamp as a result of the biasing force urging the fingers toward the laterally inward positions.

In the illustrated example, with reference to FIG. 6A, three lamp-mounting clips 1104₁, 1104₂, 1104₃ are affixed to the bracket body 1102 of each of the first and second brackets 1100₁, 1100₂. The lamp-mounting clips 1104₁, 1104₂, 1104₃, in the illustrated example, are spaced apart lengthwise along each bracket body 1102, and aligned with a corresponding one of the lamp-mounting clips 1104₁, 1104₂, 1104₃ of adjacent bracket 1100. A grow lamp may extend transversely between each of the first and second brackets 1100₁, 1100₂, and be engaged by respective lamp-mounting clips 1104₁, 1104₂, 1104₃ of each of the first and second brackets 1100₁, 1100₂. In this arrangement, light emitted by the grow lamp can be directed toward a lower plant tray (e.g., see grow lamps 122 in FIG. 2). The support apparatus 1000, in the illustrated example, can retain up to three grow lamps at a time. The number of grow lamps secured to the lamp-mounting clips 1104 may be based on one or more factors (e.g., the lighting needs of the plant species contained in the lower plant tray, the intensity of each grow lamp, vertical spacing between support apparatuses 1000, power requirements, etc.).

Referring again to FIG. 6D, the first and second fingers 1112, 1114 extend downwardly from a finger proximal end 1142 to a finger distal end 1144. The finger distal ends 1144 each have an optional inwardly facing catch 1146. In the illustrated example, the inwardly facing catches 1146 engage an underside surface of the grow lamp received between the fingers of the lamp-mounting clip 1104. The inwardly facing catches 1146 further ensure retention of the grow lamps 1122 by the lamp-mounting clips 1104, and may inhibit unintended disengagement of the grow lamp 1122 from the lamp-mounting clip 1104.

In the illustrated example, the proximal finger ends 1142 of each lamp-mounting clip 1104 are affixed to the body lower surface 1158 of the respective bracket 1100. In an alternative example, lamp-mounting clip(s) 1104 may be attached to the platform lower surface 1010 (i.e., laterally offset from the body lower surface 1158 of the respective bracket 1100). These lamp-mounting clip(s) are considered affixed to the bracket body 1102 due to the integration of the bracket body 1102 and the platform 1002.

In the illustrated example, the body lower surface 1158 includes an upwardly extending recess 1160 for each of the lamp-mounting clips 1104. In the illustrated example, the bracket 1100 includes three lamp-mounting clips 1104₁, 1104₂, 1104₃, and the body lower surface 1158 includes three corresponding recesses 1160₁, 1160₂, 1160₃. Each recess 1160 extends toward the body upper surface 1110. Each recess 1160 is bounded at least in part by recess sidewalls 1162, 1164 and a recess end wall 1166 extending between the upper (inner) ends of recess sidewalls 1162, 1164. The proximal finger ends 1142 of each lamp-mounting clip 1104 are, in the illustrated example, affixed to the recess end wall 1166 of the corresponding recess 1160.

Referring to FIG. 6B, the platform 1002, in the illustrated example, includes an optional first outboard portion integrally formed with and extending laterally from the bracket body 1102 of the first bracket 1100₁. In the illustrated example, the platform 1002 further includes an optional second outboard portion integrally formed with and extending laterally from the bracket body 1102 of the second bracket 1100₂. The first and second outboard portions 1020, 1022 extend the width of the platform 1002. In some examples, the width of the platform 1002 is sized to approximate the length of the grow lamp retained by the lamp-mounting clips 1104. Alternatively, or in addition, the width of the platform 1002 may be based on the length of the plant tray supported by the platform 1002. For example, the width of the platform 1002 may be sized to support two side-by-side plant trays.

Referring still to FIG. 6B, in the illustrated example, the platform 1002 is formed as a rectilinear series of longitudinally extending webs 1024 and laterally extending webs 1026 with openings 1028 in between. The series of horizontally and vertically extending webs 1024, 1026 provide the platform 1002 with a rigid structure while reducing material cost and weight. The openings 1028 in the platform 1002 represent omitted material that is not essential in providing the platform 1002 with the structural rigidity needed to support one or more plant trays above the ground. In the illustrated example, the platform upper surface 1008 is formed by upper surfaces of the horizontally and vertically extending webs 1024, 1026. Similarly, the platform lower surface 1010 is, in the illustrated example, formed by lower surfaces of the horizontally and vertically extending webs 1024, 1026.

Referring again to FIG. 6A, in the illustrated example, the longitudinal webs 1024 optionally include upwardly extending recesses 1030 that are sized to accommodate an upper end of a retained grow lamp. Each recess 1030 is laterally aligned with corresponding ones of the lamp-mounting clips 1104₁, 1104₂, 1104₃. When a grow lamp extends transversely between and is engaged by a corresponding pair of lamp-mounting clips 1104₁, 1104₂, 1104₃, the laterally aligned recesses 1030 which correspond to the pair of clips engaged with the grow lamp receive the upper end of that grow lamp. The upwardly extending recesses 1030 further ensure retention of the grow lamps and may inhibit unintended disengagement of the grow lamp from the lamp-mounting clips 1104.

Referring now to FIG. 7, a kit 1200 for a vertical garden includes the plant tray support apparatus 1000 and a grow lamp 122. The lamp-mounting clips 1104 of the support apparatus 1000 are sized to accommodate the grow lamp 122. In some examples, the kit 1200 includes more than one support apparatus 1000 (e.g., 2 to 6, or more). In some examples, the kit 1200 includes more than one grow lamp 122 (e.g., 2 to 12, or more). As an example, the kit 1200 may include two support apparatuses 1000 and four grow lamps 122. As another example, the kit 1200 may include four support apparatuses 1000, and twelve grow lamps 122.

While the above description provides examples of one or more apparatuses or methods, it will be appreciated that other apparatuses or methods may be within the scope of the accompanying claims.

1. A bracket for positioning between an upper plant tray and a lower plant tray, the bracket comprising:
a bracket body having a body proximal end attachable to a vertical support surface, and a body distal end spaced apart from the body proximal end, the bracket body having a body upper surface extending lengthwise between the body proximal end and the body distal end for supporting the upper plant tray; and
at least one lamp-mounting clip affixed to the bracket body, each of the lamp-mounting clips includes a first finger and a second finger spaced apart from the first finger lengthwise along the bracket body to retain a grow lamp between the first and second fingers and beneath the body upper surface.

2. The bracket of claim 1, wherein the bracket body and the at least one lamp-mounting clip are of unitary construction.

3. The bracket of claim 1, wherein the first and second fingers of each lamp-mounting clip are resiliently flexible between laterally inward and outward positions, biased to the inward position, and urged towards the outward position when the grow lamp is received between the first and second fingers.

4. The bracket of claim 3, wherein the first and second fingers of each lamp-mounting clip extend downwardly from a finger proximal end to a finger distal end.

5. The bracket of claim 4, wherein the finger distal ends of each lamp-mounting clip have an inwardly facing catch for engaging an underside surface of the grow lamp retained by the lamp-mounting clip.

6. The bracket of claim 4, wherein the bracket body has a body lower surface opposite the body upper surface, the proximal finger ends of each lamp-mounting clip being affixed to the body lower surface.

7. The bracket of claim 6, wherein the body lower surface includes at least one recess extending towards the body upper surface, each recess being bounded at least in part by recess sidewalls and a recess end wall extending between the recess sidewalls, the proximal finger ends of each lamp-mounting clip being affixed to the recess end wall of a respective one of the at least one recess.

8. The bracket of claim 7, wherein each of the first and second fingers have a finger outer surface directed toward a respective one of the recess sidewalls, the finger outer surface being spaced apart from the respective sidewall when in the laterally inward position.

9. The bracket of claim 8, wherein the finger outer surface abuts the respective recess sidewall when in the laterally outward position.

10. The bracket of claim 1, wherein the at least one lamp-mounting clip is a plurality of lamp-mounting clips that are spaced apart lengthwise along the bracket body.

11. A vertical garden assembly comprising:
a vertical support surface including a first mounting aperture and a second mounting aperture spaced vertically below the first mounting aperture;
a set of first brackets mounted to the first mounting aperture in horizontally spaced apart relation;
a set of second brackets mounted to the second mounting aperture in horizontally spaced apart relation;
each of the first and second brackets including:
a bracket body having a body proximal end proximate the vertical support surface, and a body distal end spaced apart from the body proximal end, the bracket body having a body upper surface extending lengthwise between the body proximal end and the body distal end, the bracket body including a bracket mount affixed to the body proximal end; and
at least one lamp-mounting clip affixed to the bracket body and directed away from the body upper surface;
a first plant tray having a first tray weight supported by the first brackets;
a second plant tray having a second tray weight supported by the second brackets; and
a grow lamp extending between and engaged by respective ones of the lamp-mounting clips of each of the first brackets, whereby light emitted from the grow lamp is directed toward the second plant tray.

12. The vertical garden assembly of claim 11, wherein adjacent ones of the first brackets are spaced apart by a first bracket gap and integrally connected to each other by a first platform bridging portion spanning the first bracket gap, and adjacent ones of the second brackets are spaced apart by a second bracket gap and integrally connected to each other by a second platform bridging portion spanning the second bracket gap.

13. The vertical garden assembly of claim 12, wherein the first platform bridging portion supports a portion of the first tray weight between the adjacent ones of the first brackets, and the second platform bridging portion supports a portion of the second tray weight between the adjacent ones of the second brackets.

14. The vertical garden assembly of claim 12, wherein each of the first and second platform bridging portions includes a platform proximal end and a platform distal end spaced apart from the platform proximal end, and each of the platform proximal ends includes a platform mount attachable to the vertical support wall.

15. The vertical garden assembly of claim 12, wherein
the first platform bridging portion has a platform upper surface, and the platform upper surface of the first platform bridging portion is co-planar with the body upper surfaces of the adjacent ones of the first brackets, and
the second platform bridging portion has a platform upper surface, and the platform upper surface of the second platform bridging portion is co-planar with the body upper surfaces of the adjacent ones of the second brackets.

16. The vertical garden assembly of claim 11, wherein each of the lamp-mounting clips includes a first finger and a second finger spaced apart from the first finger lengthwise along the bracket body.

17. A plant tray support apparatus attachable to a vertical support surface between an upper plant tray and a lower plant tray, the support apparatus comprising:
a platform having a platform proximal end and a platform distal end spaced apart from the platform proximal end, the platform having a platform upper surface extending lengthwise between the platform proximal end and the platform distal end for supporting a weight of the upper plant tray, the platform having a platform lower surface opposite the platform upper surface, and a plurality of lamp-mounting clips affixed to the platform lower surface, each of the lamp-mounting clips including a first finger and a second finger spaced apart from the first finger lengthwise along the platform to retain a grow lamp between the first and second fingers and beneath the platform upper surface; and
a first bracket and a second bracket laterally spaced apart from the first bracket to support the platform, wherein the first and second brackets are laterally spaced apart by a bracket gap and integrally connected to each other by a platform bridging portion of the platform that spans the bracket gap,
wherein the platform and the first and second brackets are of unitary construction.

18. The support apparatus of claim 17, wherein each of the first and second brackets comprises a bracket body extending between the platform proximal end and the platform distal end.

19. The support apparatus of claim 17, wherein the platform includes:
a first outboard portion integrally formed with and extending laterally from the bracket body of the first bracket to increase a width of the platform; and
a second outboard portion integrally formed with and extending laterally from the bracket body of the second bracket to further increase the width of the platform.

20. A kit for a vertical garden assembly, the kit comprising:
the support apparatus of claim 17; and
a grow lamp retainable by one or more of the plurality of the lamp-mounting clips.
